(19) United States
(12) Patent Application Publication
(10) Pub. No.: US 2014/0023910 A1
(43) Pub. Date: Jan. 23, 2014

(54) METHOD FOR MANUFACTURING AN ELECTRODE STACK OF AN ELECTROCHEMICAL CELL AND AN ELECTRODE STACK OF AN ELECTROCHEMICAL CELL

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 13/944,844

(22) Filed: Jul. 17, 2013

Related U.S. Application Data
(60) Provisional application No. 61/672,316, filed on Jul. 17, 2012.

(30) Foreign Application Priority Data
Jul. 17, 2012 (DE) 10 2012 014 123.8

(51) Int. Cl. H01M 10/04

(52) U.S. Cl. CPC H01M 10/0459
USPC 429/160; 29/623.1

(57) ABSTRACT

The electrode stack of an electrochemical cell for a battery includes at least one separator band and a first number of first electrodes of first polarity, wherein the separator band is disposed in a Z-fold such that a first number of spaces of first electrode receiving spaces are formed. The first electrodes exhibiting a first limb and a second limb as well as a connecting region are configured such that the respective first limb and second limb of the first electrodes are arranged in the first electrode receiving spaces formed by the separator band.

This application claims the benefit of U.S. Provisional Patent Application Ser. No. 61/672,316, filed on Jul. 17, 2012, which is incorporated herein by reference in its entirety. This application also claims priority to German Patent Application 10 2012 014 123.8, filed Jul. 17, 2012, which is incorporated herein by reference in its entirety.

The invention relates to a method for manufacturing an electrode stack of an electrochemical cell for a battery as well as an electrode stack of an electro-chemical cell for a battery and in particular relates to a method for manufacturing an electrode stack of an electrochemical cell for a battery designed for use in motor vehicles as well as an electrode stack of an electrochemical cell for a battery designed for use in motor vehicles.

Different methods of manufacturing an electrode stack of an electrochemical cell as well as different electrode stacks for electrochemical cells are known from the prior art. Improved manufacturing methods for electrode stacks of electro-chemical cells and/or the respective electrode stacks of electrochemical cells are particularly desirable for applications used in motor vehicles.

The present invention is based on the objective of providing an improved method for manufacturing an electrode stack of an electrochemical cell as well as an improved electrode stack of an electrochemical cell.

This objective is accomplished by an electrode stack in accordance with claim 1, a method of manufacturing an electrode stack in accordance with claim 10 as well as a battery in accordance with claim 17. The dependent claims relate to advantageous further developments of the invention.

In the case of an electrode stack of an electrochemical cell for a battery, particularly a battery designed for use in motor vehicles, wherein the electrode stack comprises at least one separator band as well as a first number of first electrodes of first polarity and a second number of second electrodes of second polarity, the objective is accomplished by the separator band being disposed in a Z-fold so that a first number of spaces of first electrode receiving spaces and a second number of spaces of second electrode receiving spaces are formed, and by the first electrodes exhibiting a first limb and a second limb as well as a connecting region arranged such that the respective first limb and second limb of the first electrodes are arranged in the first electrode receiving spaces formed by the separator band and disposed substantially parallel and the second electrodes exhibit a first limb and a second limb as well as a connecting region arranged such that the respective first limb and second limb of the second electrodes are arranged in the second electrode receiving spaces formed by the separator band and disposed substantially parallel. One advantage of this arrangement is being able to increase the stability of the electrode stack.

As relates to the present invention, an electrochemical cell is to be understood as an electrochemical energy store; i.e. a device which stores energy in chemical form, releases it to an electrical load in electrical form, and can preferably also absorb it in electrical form from a charging device. Galvanic cells and fuel cells are important examples of such electrochemical energy stores. The electrochemical cell comprises at least one first and one second device designed as electrode assemblies for storing electrically different charges as well as means for producing an operative electrical connection between both cited devices, whereby charge carriers can be positioned between said two devices. The means for producing an operative electrical connection is for example to be understood as an electrolyte acting as an ion conductor.

A retaining apparatus is preferentially arranged and configured around the electrode stack for its fixation. It is further preferential for the separator band to be of permeant arrangement and configuration for the fixation of the electrode stack. One advantage of this design is that fixing the electrode stack as such improves the contact.

The respective first limb of the first electrode and the second limb of the first electrode are preferentially arranged in the next but one adjacently arranged first electrode receiving spaces in the electrode stack. One advantage of this arrangement is being able to stabilize and simplify the electrode stack structure.

It is preferred for the electrode stack that the connecting region of the first electrode exhibits a preferably flattened contact surface which is arranged and configured for the first electrode contact with a first conducting section. One advantage of this design is being able to improve the contact between the first conducting section and the first electrodes.

It is preferred for the electrode stack that the contact surfaces of the first electrode are arranged substantially in one plane with the first conducting section. One advantage of this design is being able to stabilize and simplify the electro-chemical cell structure.

It is preferred for the electrode stack that the connecting region of the first electrode exhibits a curved region arranged such that the first electrodes are of substantially U-shaped configuration. The connecting region of the second electrode further exhibits a curved region arranged such that the second electrodes are of substantially U-shaped configuration. One advantage of this design is being able to additionally stabilize and simplify the electrochemical cell structure.

The respective first limb of the second electrode and the second limb of the second electrode in the electrode stack are preferentially arranged in the next but one adjacent and substantially parallel arranged second electrode receiving spaces. One advantage of this arrangement is being able to further stabilize and simplify the electrode stack structure.

It is preferred for the electrode stack that the connecting region of the second electrode exhibits a preferably flattened contact surface which is arranged and configured for the contact of the second electrode with a second conducting section.

It is preferred for the electrode stack that the contact surfaces of the second electrode are arranged substantially in one plane with the second conducting section. One advantage of this arrangement is being able to improve the contact between the second conducting section and the second electrodes.

The objective is further accomplished by a method for manufacturing an electrode stack comprising at least one separator band and a first number of first electrodes of substantially U-shaped configuration of first polarity and a second number of second electrodes of substantially U-shaped configuration of second polarity in that the method comprises the following steps: a step of arranging the separator band in a Z-fold by means of a guiding device so that first electrode receiving spaces for the first electrodes are formed in one direction and second electrode receiving spaces for the second electrodes are formed in a second direction opposite to the first direction, a step of introducing the first electrodes into the first electrode receiving spaces, a step of introducing the second electrodes into the second electrode receiving spaces, a step of affixing a first conducting section to each respective contact surface arranged in a connecting region for the first electrodes and a step of affixing a second conducting section to each respective contact surface arranged in a connecting region for the second electrodes. One advantage of this design is being able to increase the capacity of the electrochemical cells. A further advantage is being able to improve the stability of the electrochemical cells.

Preferentially, the method step of introducing the first electrodes comprising a first limb and a second limb into the first electrode receiving spaces is realized such that the respective first limb of the first electrode and the second limb of the first electrode are introduced into next but one adjacently and substantially parallel arranged first electrode receiving spaces. One advantage of this method is being able to further improve the stability of the electrochemical cells.

Preferentially, the method step of introducing the second electrodes comprising a first limb and a second limb into the second electrode receiving spaces is realized such that the respective first limb of second electrodes and the second limb of second electrodes are introduced into next but one adjacently and substantially parallel arranged second electrode receiving spaces.

The method preferentially comprises a step of compacting the Z-fold. One advantage of this design is being able to further increase the capacity of the electrochemical cells.

The step of compacting the Z-fold preferentially comprises at least one of the following steps: a step of affixing a retaining apparatus such that it is disposed around the electrode stack so as to fix it and/or a step of affixing a retaining apparatus such that it is disposed to pass through the separator band to fix the electrode stack. One advantage of this arrangement is that such fixing of the electrode stack improves the contact.

The method preferentially comprises a welding procedure in the step of affixing the first conducting section to the respective contact surface arranged in the connecting region of the first electrode which is selected from among a group of welding procedures which comprise: laser welding for connecting the first conducting section to the first electrodes, cold welding for connecting the first conducting section to the first electrodes, friction welding for connecting the first conducting section to the first electrodes and/or ultrasonic welding for connecting the first conducting section to the first electrodes. One advantage of this configuration is improved contact between the first conducting section and the first electrodes.

The method preferentially comprises a welding procedure in the step of affixing the second conducting section to the respective contact surface arranged in the connecting of the second electrode region which is selected from among a group of welding procedures which comprise: laser welding for connecting the second conducting section to the second electrodes, cold welding for connecting the second conducting section to the second electrodes, friction welding for connecting the second conducting section to the second electrodes and/or ultrasonic welding for connecting the second conducting section to the second electrodes. One advantage of this configuration is improved contact between the second conducting section and the second electrodes.

The objective is further accomplished by a battery having an electrochemical cell in that the electrochemical cell comprises at least one electrode stack as described above and/or by the electrochemical cell comprising at least one electrode stack produced pursuant one of the above-cited manufacturing methods.

In the following, aspects of the invention are described in greater detail referring to preferred embodiments and the figures. Shown are:

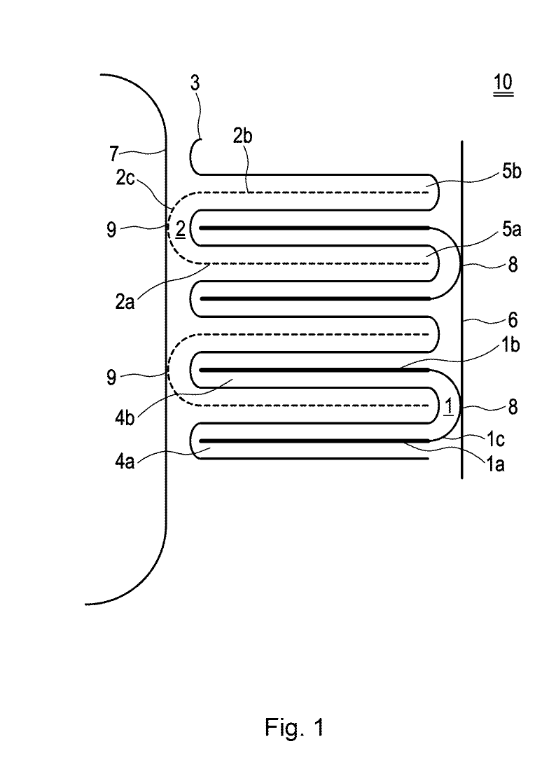

FIG. 1 a schematic depiction of an electrode stack in accordance with one embodiment, and

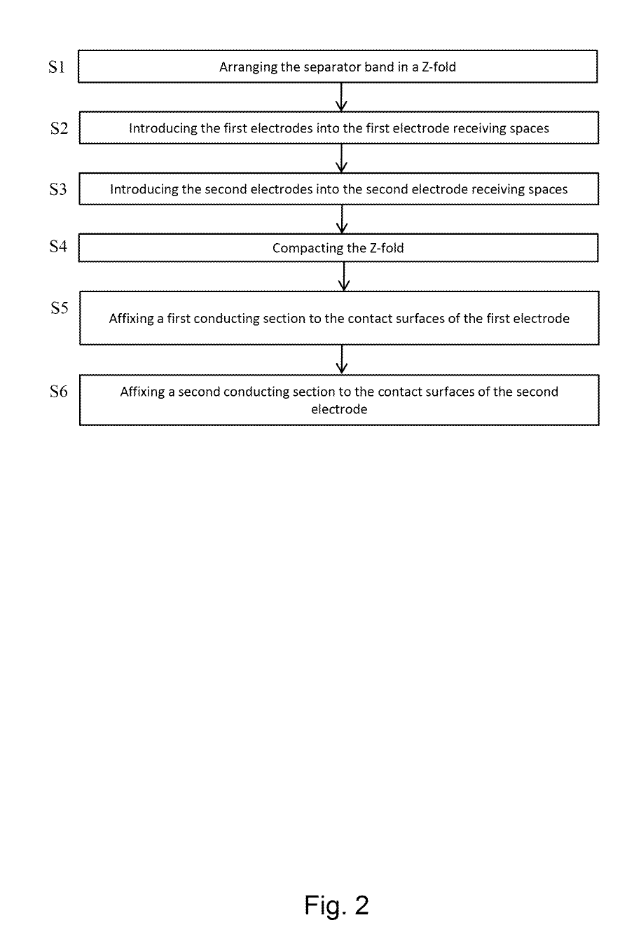

FIG. 2 a flow chart of a method for manufacturing an electrode stack in accordance with one embodiment.

FIG. 1 shows a schematic depiction of an electrode stack 10 in accordance with one embodiment of the present invention. The electrode stack 10 comprises at least one separator band 3 disposed in a Z-fold to form the first electrode receiving spaces 4a, 4b for the first electrodes 1 of first polarity and the second electrode receiving spaces 5a, 5b for the second electrodes 2 of second polarity. The first electrodes 1 exhibit a first limb 1a and a second limb 1b as well as a connecting region 1c having a contact surface 8 and the second electrodes 2 exhibit a first limb 2a and a second limb 2b as well as a connecting region 2c having a contact surface 9.

The first limb 1a of the first electrode 1 and the second limb 1b of the first electrode 1 are disposed in adjacent but one arranged first electrode receiving spaces 4a and 4b while the first limb 2a of the second electrode 2 and the second limb 2b of the second electrode 2 are disposed in adjacent but one arranged second electrode receiving spaces 5a and 5b. In the embodiment depicted in FIG. 1, the respective second limb 1b of the first electrode 1 is surrounded by the first limb 2a of the second electrode 2 and the second limb 2b of the second electrode 2 while the first limb 2a of the second electrode 2 is surrounded by the first limb 1a of the first electrode 1 and the second limb 1b of the first electrode 1.

A first conducting section 6 is affixed to the contact surfaces 8 of the first electrode 1 while a second conducting section 7 is affixed to the contact surfaces 9 of the second electrode 2.

FIG. 2 shows a flow chart of a method for manufacturing an electrode stack 10 in accordance with one embodiment of the present invention. In a step S1, the separator band 3 is arranged in a Z-fold so as to form first electrode receiving spaces 4a, 4b for the first electrodes 1 in one direction and second electrode receiving spaces 5a, 5b for the second electrodes in a second direction opposite to the first direction. In a step S2, the first electrodes 1 are introduced into the first electrode receiving spaces 4a, 4b and in a step S3, the second electrodes 2 are introduced into the second electrode receiving spaces 5a, 5b. The step S1 of arranging the separator band 3 in the Z-fold, the step S2 of introducing the first electrodes 1 into the first electrode receiving spaces 4a, 4b and the step S3 of introducing the second electrodes 2 into the second electrode receiving spaces 5a, 5b can take place successively or substantially synchronized concurrently.

In one preferential embodiment, the step S1 of arranging the separator band 3 in the Z-fold and step S2 of introducing the first electrodes 1 into the first electrode receiving spaces 4a, 4b and step S3 of introducing the second electrodes 2 into the second electrode receiving spaces 5a, 5b is followed by a step S4 of compacting the Z-fold.

After the step S1 of arranging the separator band 3 into the Z-fold, the step S2 of introducing the first electrodes 1 into the first electrode receiving spaces 4a, 4b and the step S3 of introducing the second electrodes 2 into the second electrode receiving spaces 5a, 5b, the method comprises a step S5 of affixing the first conducting section 6 to the contact surfaces 8 of the first electrodes 1 and a step S6 of affixing the second conducting section 7 to the contact surfaces 9 of the second electrodes 2. The Step S5 of affixing the first conducting section 6 and the step S6 of affixing the second conducting section 7 are preferentially realized by means of a welding procedure, wherein the welding procedure can comprise: a laser welding to connect the first conducting section 6 to the first electrodes 1 or respectively the second conducting section 7 to the second electrodes 2, and/or a cold welding to connect the first conducting section 6 to the first electrodes 1 or respectively the second conducting section 7 to the second electrodes 2, and/or a friction welding to connect the first conducting section 6 to the first electrodes 1 or respectively the second conducting section 7 to the second electrodes 2, and/or ultrasonic welding to connect the first conducting section 6 to the first electrodes 1 or respectively the second conducting section 7 to the second electrodes 2.

### LIST OF REFERENCE NUMERALS

1 first electrode

1a first limb of the first electrode

1b second limb of the first electrode

1c connecting region of the first electrode

2 second electrode

2a first limb of the second electrode

2b second limb of the second electrode

2c connecting region of the second electrode

3 separator band

4a, 4b first electrode receiving space

5a, 5b second electrode receiving space

6 first conducting section

7 second conducting section

8 contact surface of the first electrode

9 contact surface of the second electrode

10 electrode stack

S1 arranging the separator band in a Z-fold

S2 introducing the first electrodes into the first electrode receiving spaces

S3 introducing the second electrodes into the second electrode receiving spaces

S4 compacting the Z-fold

S4a affixing a retaining apparatus around the electrode stack

S4b affixing a retaining apparatus passing through the separator band

S5 affixing a first conducting section to the contact surfaces of the first electrode

S6 affixing a second conducting section to the contact surfaces of the second electrode

1-17. (canceled)

18. An electrode stack of an electrochemical cell for a battery, particularly a battery designed for use in motor vehicles, the electrode stack comprising:
at least one separator band;
a first number of first electrodes of first polarity; and
a second number of second electrodes of second polarity,
wherein
the separator band is disposed in a Z-fold so that a first number of spaces of first electrode receiving spaces and a second number of spaces of second electrode receiving spaces are formed,
the first electrodes exhibit a first limb and a second limb as well as a connecting region arranged such that the respective first limb and second limb of the first electrodes are arranged in the first electrode receiving spaces formed by the separator band and disposed substantially parallel, and
the second electrodes exhibit a first limb and a second limb as well as a connecting region arranged such that the respective first limb and second limb of the second electrodes are arranged in the second electrode receiving spaces formed by the separator band and disposed substantially parallel.

19. The electrode stack according to claim 18, wherein at least one retaining apparatus is arranged and configured around the electrode stack for fixation and/or arranged and configured to pass through the separator band for the fixation of the electrode stack.

20. The electrode stack according to claim 18, wherein the respective first limb of the first electrode and the second limb of the first electrode are arranged in the next but one adjacently arranged first electrode receiving spaces.

21. The electrode stack according to claim 20, wherein the connecting region of the first electrode exhibits a preferably flattened contact surface which is arranged and configured for a contact of the first electrode with a first conducting section.

22. The electrode stack according to claim 21, wherein the contact surfaces of the first electrode are arranged substantially in one plane with the first conducting section.

23. The electrode stack according to claim 18, wherein the connecting region of the first electrode exhibits a curved region disposed such that the first electrodes are of substantially U-shaped configuration and/or that the connecting region of the second electrode exhibits a curved region disposed such that the second electrodes are of substantially U-shaped configuration.

24. The electrode stack according to claim 23, wherein the respective first limb of the second electrode and the second limb of the second electrode are arranged in the next but one adjacently and substantially parallel arranged second electrode receiving spaces.

25. The electrode stack according to claim 24, wherein the connecting region of the second electrode exhibits a preferably flattened contact surface which is arranged and configured for the contact of the second electrode with a second conducting section.

26. The electrode stack according to claim 25, wherein the contact surfaces of the second electrode are arranged substantially in one plane with the second conducting section.

27. A method for manufacturing an electrode stack comprising at least one separator band and a first number of first electrodes of first polarity and a second number of second electrodes of second polarity in accordance with claim 18, the method comprising:
arranging the separator band in a Z-fold by means of a guiding device so that first electrode receiving spaces for the first electrodes are formed in one direction and second electrode receiving spaces for the second electrodes are formed in a second direction opposite to the first direction,
introducing the first electrodes into the first electrode receiving spaces,
introducing the second electrodes into the second electrode receiving spaces,
affixing a first conducting section to each respective contact surface arranged in a connecting region of the first electrode, and
affixing a second conducting section to each respective contact surface arranged in a connecting region of the second electrode.

28. The method according to claim 27, wherein the first electrodes comprise a first limb and a second limb, the step of introducing the first electrodes into the first electrode receiving spaces being realized such that the respective first limb of the first electrode and the second limb of the first electrode are introduced into next but one adjacent and substantially parallel arranged first electrode receiving spaces.

29. The method according to claim 27, wherein the second electrodes comprise a first limb and a second limb, the step of introducing the second electrodes into the second electrode receiving spaces being realized such that the respective first limb of the second electrode and the second limb of the second electrode are introduced into next but one adjacent and substantially parallel arranged second electrode receiving spaces.

30. The method according to claim 29, further comprising:
after the step of introducing the second electrodes into the second electrode receiving spaces, compacting the Z-fold of the separator band.

31. The method according to claim 30, wherein the step of compacting the Z-fold comprises at least one of the following steps:
affixing a retaining apparatus such that it is disposed around the electrode stack (10) so as to fix it, or
affixing a retaining apparatus such that it is disposed to pass through the separator band to fix the electrode stack.

32. The method according to claim 27, wherein the step of affixing the first conducting section to the respective contact surface arranged in the connecting region of the first electrode comprises a welding procedure selected from among a group of welding procedures consisting of: a laser welding for connecting the first conducting section to the first electrodes, a cold welding for connecting the first conducting section to the first electrodes, a friction welding for connecting the first conducting section to the first electrodes, and an ultrasonic welding for connecting the first conducting section to the first electrode.

33. The method according to claim 27, wherein the step of affixing the second conducting section to the respective contact surface arranged in the connecting region of the second electrode comprises a welding procedure selected from among a group of welding procedures which comprise: a laser welding for connecting the second conducting section to the second electrodes, a cold welding for connecting the second conducting section to the second electrodes, a friction welding for connecting the second conducting section to the second electrodes and/or an ultrasonic welding for connecting the second conducting section to the second electrode.

34. A battery having at least one electrochemical cell, wherein the electrochemical cell comprises at least one electrode stack according to claim 18.

35. A battery having at least one electrochemical cell, wherein the electrochemical cell comprises at least one electrode stack manufactured in accordance with the method of claim 27.
